(19) United States
(12) Patent Application Publication
(10) Pub. No.: US 2024/0412529 A1
(43) Pub. Date: Dec. 12, 2024

(54) TARGET DETECTION METHOD, VEHICLE, COMPUTING DEVICE AND COMPUTER-READABLE STORAGE MEDIUM

(71) Applicant: Beijing Tusen Zhitu Technology Co., LTD., Beijing (CN)

(72) Inventors: Feng Wang, Beijing (CN); Naiyan Wang, Beijing (CN)

(73) Assignee: Beijing Tusen Zhitu Technology Co., LTD., Beijing (CN)

(21) Appl. No.: 18/738,837

(22) Filed: Jun. 10, 2024

(30) Foreign Application Priority Data
Jun. 12, 2023 (CN) 202310696496.X

(51) Int. Cl. G06V 20/56; G06T 7/20; G06V 10/762

(52) U.S. Cl. CPC G06V 20/56; G06T 7/20; G06V 10/762; G06T 2207/30204; G06V 2201/07

(57) ABSTRACT

The present disclosure provides a target detection method, a vehicle, a computing device, and a computer-readable storage medium, wherein the target detection method includes: acquiring historical sensor data corresponding to each of a plurality of historical frames, wherein the plurality of historical frames precede a current frame on a time series; generating a reference detection marker corresponding to at least one target object in the current frame according to the historical sensor data of each historical frame; and generating a target detection result in the current frame according to each reference detection marker. With the method provided by the present disclosure, the problem of missing detection or false detection due to occlusion problems is avoided, the detection effect of performing the target detection method is enhanced, and the accuracy of detection is improved.

The present disclosure claims priority to Chinese patent application No. 202310696496.X, titled “TARGET DETECTION METHOD, VEHICLE, COMPUTING DEVICE AND COMPUTER-READABLE STORAGE MEDIUM”, filed on Jun. 12, 2023, the content of which is incorporated herein by reference in its entirety.

### TECHNICAL FIELD

The present disclosure relates to the field of computer technology and, in particular, to a target detection method. The present disclosure simultaneously relates to a vehicle to which the target detection is applied, a computing device, and a computer-readable storage medium.

### BACKGROUND

In the three-dimensional point cloud target detection task, it is necessary to predict the three-dimensional bounding box of the object based on the three-dimensional point cloud information. Currently, the three-dimensional target detection method with a single-frame point cloud as input only outputs a detection result of the current frame, and there is often no prediction frame when the target is occluded. Some other detection methods also introduce the way of multi-frame result fusion to perform target detection, such as coding by a complex multi-layer network structure and fusing the feature information between multi-frames, which can improve the detection results. However, it needs to use a specific network structure, requires additional model parameters and multi-stage model training, and will introduce higher delay in the model processing, which is not applicable to a use scenario with higher real-time requirements. Therefore, a new target detection method is urgently needed to solve the current problem of inaccurate target detection.

### SUMMARY

In view of the foregoing, embodiments of the present disclosure provide a target detection method. The present disclosure also relates to a vehicle to which the target detection is applied, a computing device, and a computer-readable storage medium to solve the above-mentioned problems in the prior art.

According to a first aspect of an embodiment of the present disclosure, a target detection method is provided, including:
acquiring historical sensor data corresponding to each of a plurality of historical frames, wherein the plurality of historical frames precede a current frame on a time series;
generating a reference detection marker corresponding to at least one target object in the current frame according to the historical sensor data of each historical frame; and
generating a target detection result in the current frame according to each reference detection marker.

According to a second aspect of an embodiment of the present disclosure, a target detection method is provided, including:
acquiring historical sensor data of a vehicle corresponding to each of a plurality of historical frames, wherein the plurality of historical frames precede a current frame on a time series;
generating a reference detection marker corresponding to at least one detected vehicle in the current frame according to historical sensor data of the vehicle for each historical frame; and
generating a target vehicle detection result in the current frame according to each reference detection marker.

According to a third aspect of an embodiment of the present disclosure, a vehicle is provided, including: a processor which, when executing computer instructions, implements the steps of the target detection method described above.

According to a fourth aspect of an embodiment of the present disclosure, a computing device is provided, including a memory, a processor and computer instructions stored on the memory and executable on the processor. The processor which, when executing the computer instructions, implements the steps of the target detection method.

According to a fifth aspect of embodiments of the present disclosure, a computer-readable storage medium is provided and stores computer instructions which, when executed by a processor, implement the steps of the target detection method.

The target detection method provided by the present disclosure includes acquiring historical sensor data corresponding to each of a plurality of historical frames, wherein the plurality of historical frames precede a current frame on a time series; generating a reference detection marker corresponding to at least one target object in the current frame according to the historical sensor data of each historical frame; and generating a target detection result in the current frame according to each reference detection marker.

Embodiments of the present disclosure includes predicting a reference detection marker in a current frame according to historical sensor data of a plurality of historical frames, generating a target detection result in the current frame by each reference detection marker. It avoids the problem of missing detection or false detection caused by an occlusion problem, enhances the detection effect of performing a target detection method, and improves the accuracy of detection by making a prediction with the historical sensor data.

### BRIEF DESCRIPTION OF THE DRAWINGS

FIG. 1 is an architectural diagram of a target detection system provided by an embodiment of the present disclosure;

FIG. 2 is a flow diagram of a target detection method provided by an embodiment of the present disclosure;

FIG. 3 is a schematic view of a single-wheel drive model and a two-wheel drive model provided by an embodiment of the present disclosure;

FIG. 4 is a process flow diagram of a target detection method applied to a roadside detection device provided by an embodiment of the present disclosure;

FIG. 5 is a schematic diagram of a target detection method provided by an embodiment of the present disclosure;

FIG. 6 is a flowchart of another target detection method provided by an embodiment of the present disclosure; and

FIG. 7 is a structural block diagram of a computing device provided by an embodiment of the present disclosure.

### DETAILED DESCRIPTION

In the following description, numerous specific details are set forth in order to provide a thorough understanding of the present disclosure. The present disclosure, however, may be practiced in many other ways than described herein, and one of ordinary skill in the art can make similar expansions without departing from the scope of the present disclosure, which is therefore not limited to the specific embodiments disclosed below.

The terminology used in the one or more embodiments of the disclosure is for the purpose of describing particular embodiments only, and is not intended to be limiting of the one or more embodiments of the disclosure. As used in one or more embodiments of the disclosure and the appended claims, the singular forms “a”, “an”, and “the” are intended to include the plural forms as well, unless the context clearly indicates otherwise. It should also be understood that the term “and/or” as used in one or more embodiments of this disclosure refers to and encompasses any and all possible combinations of one or more of the associated listed items.

It should be understood that, although the terms first, second, etc. may be used to describe various information in one or more embodiments of the present disclosure, such information should not be limited to these terms. These terms are only used to distinguish one type of information from another. For example, the first may also be referred to as the second, and similarly, the second may also be referred to as the first, without departing from the scope of one or more embodiments of the present disclosure. Depending on the context, the word “if” as used herein may be interpreted as “as” or “when” or “in response to a determination”.

It should be noted that the user information (including but not limited to user equipment information, user personal information, etc.) and data (including but not limited to data used for analysis, stored data, displayed data, etc.) involved in the present disclosure are information and data authorized by the user or fully authorized by all parties. In addition, the collection, use and processing of relevant data need to comply with relevant laws and regulations and standards of relevant countries and regions, and provide a corresponding operation entrance for the user to choose to authorize or deny.

First, the terminology referred to in one or more embodiments of the disclosure is explained.

Target Detection: the position of the target object is found in the raw sensor data by an algorithm, and the position of the target object in two-dimensional (2D) or three-dimensional (3D) space is generally represented by a rectangle or a cuboid.

Point Cloud: the data of surrounding environment collected by a point cloud device (such as Lidar or stereo-camera) is represented by a set of sparse three-dimensional space points.
intersection over union: the ratio of the volume of the intersection of two 3D detection boxes to the volume of their union, or the ratio of surface area of the intersection of two 2D detection boxes to the surface area of their union.

Detection box pose p=(x, y, ϕ): x-axis and y-axis coordinates, and an orientation angle ϕ of a center point of the detection box.

In the three-dimensional point cloud target detection task, it is necessary to predict the three-dimensional bounding box of the object based on the three-dimensional point cloud information. Currently, the three-dimensional target detection method with a single-frame point cloud as input only outputs a detection result of the current frame, and there is often no prediction frame when the target is occluded. Some detection methods introduce multi-frame result fusion for target detection, and use time sequence information to further improve the detection effect. For example, MppNet encodes and merges multi-frame features by a complex three-layer structure, but this method requires a specific network structure and cannot be directly applied to existing three-dimensional detectors. In addition, this method requires additional model parameters and multi-stage training. At the same time, this method also introduces a higher delay, which makes it difficult to cope with some application scenarios with higher real-time requirements.

Based on the above problems, the present disclosure provides a target detection method, and the present disclosure simultaneously relates to a vehicle to which the target detection is applied, a computing device, and a computer-readable storage medium. The following embodiments are described in detail one by one.

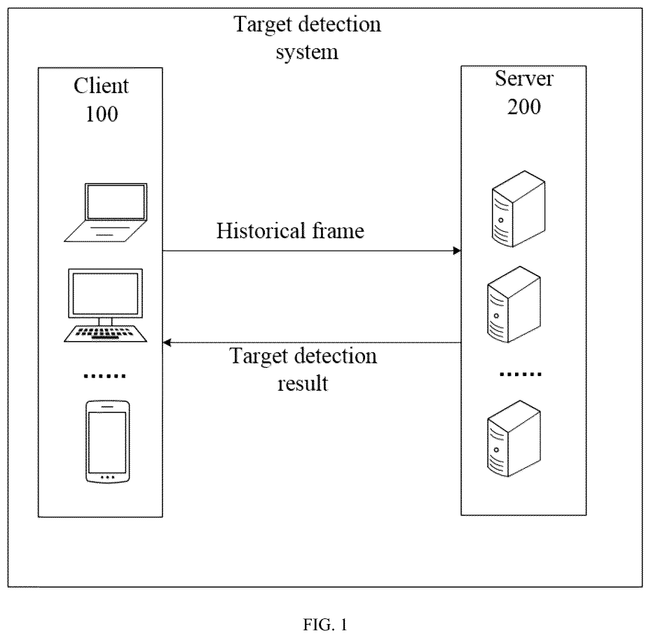

With reference to FIG. 1, FIG. 1 is an architectural diagram of a target detection system provided by an embodiment of the present disclosure. The target detection system may include a client 100 and a server 200.

The client 100 is configured for sending a plurality of historical frames to the server 200. In a time series, the plurality of historical frames precede the current frame, and each historical frame includes historical sensor data.

The server 200 is configured for acquiring historical sensor data corresponding to each of a plurality of historical frames, generating a reference detection marker corresponding to at least one target object in the current frame according to the historical sensor data of each historical frame, and generating a target detection result in the current frame according to each reference detection marker; and sending the target detection result to the client 100.

The client 100 is also configured for receiving the target detection result sent by the server 200.

The target detection system may include a plurality of clients 100 and a server 200. The client 100 may be referred to as an end-side device, and the server 200 may be referred to as a cloud-side device. The communication connection may be established between the plurality of clients 100 via the server 200. In an automatic driving scenario, the server 200 is configured for providing a target detection service between the plurality of clients 100, and the plurality of clients 100 may respectively serve as a sending end or a receiving end to realize communication via the server 200.

The user may interact with the server 200 via the client 100 to receive data sent by other clients 100, or send data to other clients 100, etc. In an automatic driving scenario, it may be that a user issues a data stream to a server 200 via a client 100. The server 200 generates a target detection result according to the data stream, and pushes the target detection result to a current client or other client establishing communication.

Herein, a connection is established between the client 100 and the server 200 via a network. The network provides a medium for communication links between the client 100 and the server 200. The network may include various connection types, such as wired, wireless communication links, or fiber optic cables, etc. The data transmitted by the client 100 may need to be encoded, transcoded, compressed, etc. before being distributed to the server 200.

The client 100 may be deployed in an electronic device, need to run on the device or some APP in the device, etc. The electronic device may e.g. have a display screen and support information browsing etc. e.g., be a personal mobile terminal such as a mobile phone, a tablet computer, a personal computer etc. Various other class applications, such as man-machine conversation class applications, model training class applications, text processing class applications, web browser applications, shopping class applications, search class applications, instant messaging tools, mailbox clients, social platform software, etc. may also typically be configured in electronic devices.

The server 200 may include servers that provide various services, such as servers that provide communication services for a plurality of clients, servers that provide support for models used on clients for background training, servers that process data sent by clients, etc. Note that the server 200 may be implemented as a distributed server cluster composed of a plurality of servers, or as a single server. The server may also be a server of a distributed system, or a server incorporating a chain of blocks. The server can also be a cloud server of a basic cloud computing service, such as a cloud service, a cloud database, cloud computing, a cloud function, cloud storage, a network service, cloud communication, a middleware service, a domain name service, a security service, a content distribution network (CDN, content Delivery Network) and a large data and artificial intelligence platform, or an intelligent cloud computing server or an intelligent cloud host with artificial intelligence technology.

It should be noted that the target detection method provided in the embodiments of the present disclosure is generally performed by a server. However, in other embodiments of the present disclosure, a client may have a similar function as the server so as to perform the target detection method provided in the embodiments of the present disclosure. In other embodiments, the target detection method provided by embodiments of the present disclosure may also be performed by a client in conjunction with a server.

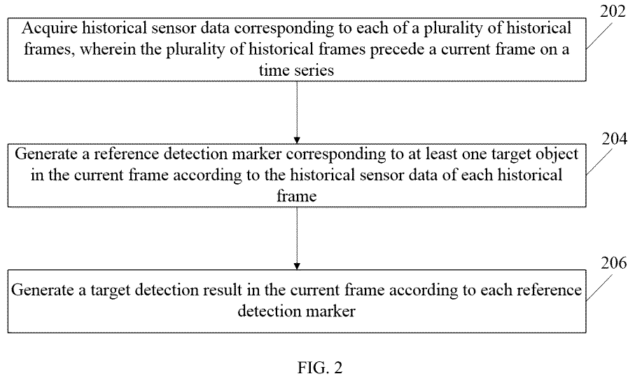

FIG. 2 shows a flow diagram of a target detection method provided by an embodiment of the present disclosure, including in particular the following steps.

Step 202: historical sensor data corresponding to each of a plurality of historical frames is acquired, where the plurality of historical frames precede a current frame on a time series.

In some embodiment, the historical frame and the current frame are both sensor data (such as multiple images or point cloud data) in a time series. In practical applications, the detection of a target object is performed via an image collected by an image collection device, and the image collection device performs image collection according to the time series. The detection of a target object is also performed via point cloud data collected by a point cloud collection device, and the point cloud collection device performs point cloud collection according to the time series. For example, in the case where the image collection device is a camera, the historical frame and the current frame are video frames in a video collected by the camera. The current frame is the image currently acquired by the image acquisition device on the current time series. The historical frame is an image acquired by the image acquisition device prior to the current frame.

In the present embodiment, the historical sensor data refers to sensor acquisition information in each historical frame. In practical applications, when the sensor device is a Lidar, the historical sensor data corresponding to the historical frame is point cloud data acquired by the Lidar. In the case where the sensor is a camera, the historical sensor data corresponding to the historical frame is image data acquired by the camera.

Acquiring a plurality of historical frames and corresponding historical sensor data in each historical frame may facilitate efficient prediction according to the historical sensor data in the historical frames during subsequent processing. To improve prediction efficiency, the plurality of historical frames are historical frames adjacent to the current frame. For example, when the current frame is a t^{th} frame in the time series, the plurality of historical frames may be a (t−1)^{th} frame, a (t−2)^{th} frame, a (t−3)^{th} frame, . . . , the (t−n)^{th} frame. In order to make subsequent predictions more accurate and reduce the amount of computation, the number of n may be set to be less than or equal to a preset threshold. In a specific implementation provided by the present disclosure, the value of n may be an integer between 3 and 10. Preferably, n may have a value of 3, 4 or 5. For example, when n has a value of 3, it is 3 historical frames before the current frame is acquired.

Step 204: a reference detection marker corresponding to at least one target object in the current frame is generated according to the historical sensor data of each historical frame.

After each historical frame is determined, a reference detection marker for at least one target object is generated in the current frame according to historical sensor data for each historical frame. The reference detection marker specifically refers to a detection marker of a target object predicted from the historical frame.

The target object in the historical frame may be detected according to the historical sensor data, so that the position of the target object in the current frame can be predicted according to the historical sensor data.

In practice, different reference detection markers may be generated in the current frame according to historical sensor data for different historical frames. For example, when there is the same target object in all three historical frames, it is possible to predict a reference detection marker 1 of the target object in the current frame according to a first historical frame. It is possible to predict a reference detection marker 2 of the target object in the current frame according to a second historical frame. It is possible to predict a reference detection marker 3 of the target object in the current frame according to a third historical frame.

In practical applications, the reference detection marker may specifically be in the form of a detection box, i.e., the reference detection marker is a reference detection box. In some embodiments, however, the reference detection marker may also be in the form of a marker dot to mark out the target object.

In a specific implementation provided by the present disclosure, the historical sensor data includes reference point cloud data. Accordingly, the generating a reference detection marker corresponding to at least one target object in the current frame according to the historical sensor data of each historical frame includes:
for each historical frame,
clustering the reference point cloud data in the historical frame to obtain at least one reference target object;
predicting reference pose information about each reference target object in the current frame; and
determining a reference detection marker corresponding to each reference target object in the current frame according to each reference pose information.

For any historical frame, in the case where the historical sensor data in the historical frame is reference point cloud data, the reference point cloud data may be clustered to obtain a corresponding initial clustering result. Specifically, each initial cluster result corresponds to a reference target object. For example, a historical frame may include reference point cloud data. After clustering the reference point cloud data in the historical frame, three initial clustering results are obtained, and then three reference target objects can be determined.

After determining each reference target object in the historical frame, the reference pose information of each reference target object in the historical frame in the current frame may be predicted according to the relationship between the historical frame and the current frame. Specifically, the reference pose information refers to prediction of position information and pose information of the reference target object in the current frame. The position information is used to represent position information (such as coordinate information) that the reference target object is predicted in the current frame, and the pose information is used to represent angle information that the reference target object is predicted in the current frame. Thereafter, a reference detection marker corresponding to each reference target object in the current frame may be determined according to the reference pose information of each reference target object.

For example, the reference pose information of the reference target object in the current frame t may be predicted from its information in the historical frame t−1. Then, a reference detection marker of the reference target object in the current frame may be determined according to the reference pose information.

Further, in one or more embodiments provided by the present disclosure, the predicting reference pose information about each reference target object in the current frame includes:
for each reference target object,
acquiring initial reference pose information about the reference target object in the historical frame.

In the embodiments of the present disclosure, the same processing may be performed for any one of the reference target objects, and one of the reference target objects is explained as an example for the convenience of explanation.

Specifically, the initial reference pose information refers to the pose information of the reference target object in its corresponding historical frame. For example, the pose information of the reference target object in its corresponding historical frame t−1 is the initial reference pose information.

After the initial reference pose information of the reference target object is determined, it can be predicted to predict the reference pose information of the reference target object in the current frame according to the initial reference pose information. Specifically, the motion of the reference target object may be predicted by a preset motion prediction model.

In practical applications, a unified motion prediction model can be used to predict each reference target object, or multiple motion prediction models can be designed to accommodate different types of reference target objects. This is not limited in this disclosure.

The predicting reference pose information about each reference target object in the current frame further includes:
for each reference target object,
1. inputting the initial reference pose information to a motion prediction model, and obtaining reference pose information about the reference target object in the current frame.

Specifically, after the initial reference pose information of each reference target object is determined, it can be input into the motion prediction model to predict the reference pose information of the reference target object in the current frame according to the initial reference pose information of the reference target object in the historical frame.

The motion prediction model refers to a mathematical model for predicting the motion trajectory of the target object, which can predict its pose information in the current frame according to the pose information of the reference target object in the historical frame. Specifically, the initial reference pose information needs to be input to the motion prediction model for making a prediction by the motion prediction model.

In a specific implementation provided by the present disclosure, the inputting the initial reference pose information to a motion prediction model includes:
acquiring motion parameter information about the reference target object; and
inputting the initial reference pose information and the motion parameter information into the motion prediction model.

In practical applications, in addition to input initial reference pose information to the motion prediction model, it is also necessary to input motion information of the reference target object to the motion prediction model. Specifically, the motion information of the reference target object may be understood as motion parameter information of the reference target object, such as a motion speed, a motion angular speed, accelerated speed, etc. After obtaining the motion parameter information, the motion parameter information and the initial reference pose information may be input to the motion prediction model.

Further, the motion parameter information of the reference target object may be determined according to at least two frames for the reference target object. For example, the motion parameter information of the reference target object may be determined according to the position information of the reference target object in several adjacent historical frames.

Specifically, the motion prediction model refers to a mathematical model for predicting a reference target object, for predicting a pose of the reference target object at a future time according to the current pose information and motion parameters of the reference target object. See Equation (1) below for details.

$${p}_{t} = {p}_{0} + {F}_{M} ( {p}_{0} , t ; {θ}_{M} ) \qquad Equation ( 1 )$$

where p₀ is current pose information; F_{M}(p₀, t; θ_{M}) is a forward model of a motion prediction model; t is a predicted moment; and θ_{M} is motion parameter information.

In a specific implementation provided by the present disclosure, the motion prediction model may be one motion prediction model or different motion prediction models provided for different types of reference target objects, which is not limited in the embodiments provided by the present disclosure.

In order to better predict the reference target object, multiple motion prediction models are preferably used in embodiments of the present disclosure to predict different types of reference target objects. Based on this, the method also includes:
determining object attribute information about the reference target object; and determining a motion prediction model corresponding to the reference target
object according to the object attribute information.

The object attribute information specifically refers to information used for embodying different motion prediction models used by the reference target object. In practical applications, the motion prediction models may include a uniform speed model, a single-wheel drive model, a two-wheel drive model, or other models.

Uniform-speed model: in the application scenario of this model, it is assumed that the velocity of the object is constant in the x and y-axis directions. From a constant speed and time, the pose information of the object at different times may be predicted. In practical applications, if only one uniform motion prediction model is designed, a uniform-speed model may be used, for example.

Single-wheel drive model: it is assumed that the object is driven by a wheel having the same pose as the object. The object may be, for example, a human, an animal, a wheelbarrow, etc. The single-wheel drive models typically involve motion parameters θ_{U} and forward models F_{U}. See Equation (2) below for motion parameters and Equation (3) below for forward model:

$${θ}_{U} = ( V , ω ) ; \qquad Equation ( 2 )$$

$${F}_{U} = [ \begin{matrix}\frac{V}{ω} ( sin {ϕ}_{t} - sin {ϕ}_{0} ) \\ \frac{V}{ω} ( cos {ϕ}_{0} - cos {ϕ}_{t} ) \\ ω t\end{matrix} ] ; \qquad Equation ( 3 )$$

where θ_{U} in Equation (2) represents motion parameters; V refers to a motion speed of the reference target object; and ω refers to an angular speed of the reference target object. ϕ₀ represents an orientation angle at a starting time, and ϕₜ represents an orientation angle at a time t after the starting time. The single-wheel drive model provides a simple way to model the motion of a steerable rigid body.

Two-wheel drive model: it is assumed that the object is driven by two wheels distributed on the central axis, such as a motorcycle, a bicycle, an automobile, etc. In the two-wheel drive model, the front wheels are rotating wheels and the rear wheels are driving wheels. The two-wheel drive model also involves motion parameters and a forward model. Specifically, the motion parameters θ_{B} of the two-wheel drive model are described in Equation (4), and the forward model F_{B} is described in Equation (5):

$${θ}_{B} = ( V , β , {l}_{r} ) ; \qquad Equation ( 4 )$$

$${F}_{B} = [ \begin{matrix}\frac{{l}_{r}}{sin β} ( sin ( {ϕ}_{t} + β ) - sin ( {ϕ}_{0} + β ) ) \\ \frac{{l}_{r}}{sin β} ( cos ( {ϕ}_{0} + β ) - cos ( {ϕ}_{t} + β ) ) \\ \frac{V sin β}{{l}_{r}} t\end{matrix} ] ; \qquad Equation ( 5 )$$

where, V refers to the speed of movement of the reference target object; β refers to a departure slip angle from the heading of the reference target object; and lᵣ is a distance between the centroid of the reference target object and two wheels. ϕ₀ represents an orientation angle at a starting time, and ϕₜ represents an orientation angle at a time t after the starting time.

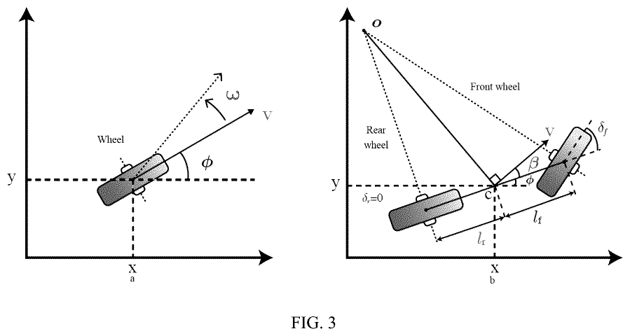

Referring to FIG. 3, FIG. 3 is a schematic view of a single-wheel drive model and a two-wheel drive model provided by the present disclosure. As shown in FIG. 3, a in FIG. 3 is a single-wheel drive model, and b in FIG. 3 is a two-wheel drive model. The single-wheel drive model is, for example, a model of a single-axle system, and the number of wheels on this single axle is not limited. The two-wheel drive model is, for example, a model of a two-axle system in which there is a spacing between the two axles, and the number of wheels on either of the two axles is not limited.

For the single-wheel drive model, the wheel moves at a speed V and rotates at an angular speed ω, the motion parameters of which are given by Equation (2). For the two-wheel drive model, the vehicle speed is V, the slip angle deviates from the vehicle heading is β. lᵣ is the distance between the centroid of the reference target object and the two wheels. Its motion parameter is Equation (4).

In a specific implementation provided by the present disclosure, the object attribute information for the reference target object is first obtained. Further, the object attribute information is configured for determining reference information about the movement pattern of the target object. The object attribute information comprises at least one of uniform-speed information, single-wheel drive information, or two-wheel drive information. For example, the reference target object is determined to have a single-wheel drive, or the reference target object is determined to have a two-wheel drive, or the reference target object is determined to have a uniform-speed. Accordingly, where the reference target object is a single-wheel drive (e.g. the reference target object is a wheelbarrow, etc.), the motion prediction model is a single-wheel drive model. When the reference target object is a human, the single-wheel drive model can also be used as a motion prediction model. In the case where the reference target object has a two-wheel drive (e.g. the reference target object is a bicycle, motorcycle, automobile, etc.), the motion prediction model is a two-wheel drive model.

After the motion prediction model corresponding to the reference target object is determined, the initial pose reference information and the motion parameter information of the reference target object are input into the motion prediction model, and the reference pose information of the reference target object in the current frame is output by the motion prediction model.

After the reference pose information about each reference target object in the current frame is acquired, it is subsequently convenient to further detect the target object in the current frame according to the reference pose information about each reference target object in the current frame, so as to improve the detection accuracy rate of the target object by the historical sensor data or other relevant information in the historical frame.

In practical applications, in addition to predicting the target object in the current frame according to the historical frames, the prediction may also be performed according to the sensor data corresponding to the current frame. In particular, in one or more implementations provided by the present disclosure, the method further includes:
acquiring current sensor data corresponding to the current frame; and
generating at least one initial detection marker corresponding to the at least one target object in the current frame according to the current sensor data.

The current sensor data specifically refers to the sensor data acquired by the image acquisition device in the current frame. When the sensor device is a Lidar, the current sensor data corresponding to the current frame is point cloud data acquired by the Lidar. In the case where the sensor device is a camera, the current sensor data corresponding to the current frame is the image data acquired by the camera.

According to the current sensor data in the current frame, an initial detection marker corresponding to the target object may be generated in the current frame. For example, where there are three target objects in the current frame, each target object may correspond to an initial detection marker.

Further, the current sensor data includes current point cloud data;
wherein the generating at least one initial detection marker corresponding to the at least one target object in the current frame according to the current sensor data includes:
clustering the current point cloud data to detect at least one current target object; and
generating an initial detection marker corresponding to each current target object.

In the case where the current sensor data is current point cloud data, similar to the reference point cloud data, the current point cloud data may be clustered to obtain a corresponding initial clustering result. Specifically, each initial cluster result corresponds to a current target object.

For example, a current frame may include a plurality of current point cloud data. After clustering the current point cloud data in the current frame, four initial clustering results are obtained, and then four current target objects may be determined.

After the current target object is determined in the current frame, an initial detection marker corresponding to each current target object may be generated. Further, the initial detection marker may be an initial detection box. In some embodiments, however, the initial detection marker may also be in the form of a marker dot to mark out the target object.

In one or more embodiments provided by the present disclosure, the generating an initial detection marker corresponding to each current target object includes:
inputting a current frame including each current target object to an object detection model; and
obtaining an initial detection result output by the object detection model, wherein the initial detection result includes the current frame, each initial detection marker in the current frame, and initial detection marker pose information about each initial detection marker.

The object detection model specifically refers to a pre-trained machine learning model for achieving target detection. In practice, the object detection model may be an artificial intelligence model based on a convolutional neural network. Specifically, a current frame including each target object is input into an object detection model, and the object detection model may detect this current frame and output a corresponding initial detection result. The initial detection result includes an initial detection marker obtained by marking each current target object on the basis of the current frame, and initial detection marker pose information about each determined initial detection marker on the basis of the current frame.

Acquiring the detection information of the current frame can jointly judge the detection information of the current frame and the prediction information predicted according to the historical frame in the subsequent processing, so that the target detection in the current frame can be more accurate.

Step 206: a target detection result in the current frame is generated according to each reference detection marker.

After acquiring each reference detection marker information, a final target detection result can be generated in the current frame according to the position information of each reference detection marker in the current frame. Specifically, whether a plurality of reference target objects are the same target object can be determined according to intersection over union information between a plurality of reference detection marker.

In practice, for the same target object, it will participate in prediction in different historical frames, and mark the reference detection marker for the same target object in the current frame. Therefore, it is necessary to detect the final target detection result in the current frame in combination with each reference detection marker.

In one or more embodiments provided by the present disclosure, where at least one initial detection marker corresponding to at least one target object is generated in the current frame according to the current sensor data, the step 206 described above further includes:
generating a target detection result in the current frame according to each initial detection marker and each reference detection marker.

In order to better realize the detection of the target object in the current frame, it is also possible to combine each reference detection marker with each initial detection marker to generate the corresponding target detection result of the current frame. Specifically, the target detection result indicates the target object detected in the current frame.

Specifically, the generating a target detection result in the current frame according to each initial detection marker and each reference detection marker may include the following steps A, B and C.

Step A: a current detection marker is determined from each initial detection marker and each reference detection marker, and at least one comparison detection marker corresponding to the current detection marker is determined.

The current detection marker specifically refers to a detection marker processed in the current frame. In practical application, in order to determine the final target detection result, corresponding processing needs to be performed on each detection marker in turn. During processing, for ease of calculation, a detection marker may first be determined for processing. The detection marker processed in the current frame is the current detection marker.

After the current detection marker is determined, at least one comparison detection marker corresponding to the current detection marker is further determined. The comparison detection marker specifically refers to a detection marker having a corresponding relationship with the current detection marker. For example, in practical applications, four target objects may be detected simultaneously, a target object 1, a target object 2, a target object 3, and a target object 4. In the case where the current detection marker is one of the detection marks of the target object 1, the corresponding at least one comparison detection marker is also the detection marker corresponding to the target object 1. That is to say, the current detection marker and the corresponding comparison detection marker belongs to a same target object.

In a specific implementation provided by the present disclosure, the determining a current detection marker from each initial detection marker and each reference detection marker, and determining at least one comparison detection marker corresponding to the current detection marker includes:
generating a set of detection markers to be processed according to each initial detection marker and each reference detection marker;
determining a current detection marker from the set of detection markers to be processed;
calculating an intersection-union ratio between the current detection marker and other detection markers in the set of detection markers to be processed; and
taking a detection marker to be processed having an intersection over union greater than or equal to a first preset threshold as the comparison detection marker corresponding to the current detection marker.

In practical applications, each initial detection marker and each reference detection marker can be taken as a detection marker to be processed, added to a set of detection markers to be processed, and then a current detection marker can be determined sequentially from the set of detection markers to be processed. Furthermore, it is possible to select one of the detection markers to be processed in the set of detection markers to be processed as the current detection marker, or to select the current detection marker from the detection markers to be processed according to a preset condition. The preset condition may be set according to actual situations, and this is not limited in the present disclosure.

In a specific implementation provided by the present disclosure, when marking, each detection marker to be processed includes a confidence coefficient of the detection marker corresponding to the detection marker to be processed. The confidence coefficient of the detection marker is used to represent the confidence level of the detection marker. In order to facilitate the determination of the current detection marker from the set of pending detection marks, the determining the current detection marker from the set of detection markers to be processed includes:
determining the current detection marker according to the confidence coefficient of the detection marker corresponding to each detection marker to be processed.

Specifically, the detection markers to be processed can be sorted according to the detection marker confidence coefficient corresponding to each detection marker to be processed, and the detection marker to be processed with the highest confidence coefficient can be selected as the current detection marker. In some embodiments, if there are at least two detection markers to be detected with the highest confidence coefficient, either of them may be randomly selected as the current detection marker.

The Intersection over Union (IoU) function can be used to calculate the ratio of the intersection and union of two bounding boxes to evaluate the area coincidence or volume coincidence of two geometries. In a target detection algorithm, the intersection over union can be used to calculate the error between the prediction block and the real block, or in a non-maximum suppression algorithm to filter redundant overlapping objects. In one or more embodiments provided by the present disclosure, the weighted non-maximum suppression is used to fuse the detection results of the historical frame and the current frame to supplement and enhance the detection of the current frame. Furthermore, after the current detection marker is determined, it is also possible to further determine which detection marks belong to the same target object as the current detection marker according to the intersection over union between the current detection marker and other detection markers.

Specifically, after determining the current detection marker, the intersection over union of the current detection marker with other detection markers in the set of detection markers to be processed may be calculated. Based on this, an association relationship between each other detection marker and the current detection marker can be obtained. After the calculation is completed, a detection marker to be processed having an intersection over union greater than or equal to a first preset threshold is taken as a comparison detection marker of the current detection marker, and at least one comparison detection marker corresponding to the current detection marker can be obtained. Here, the first preset threshold may be a preset threshold for determining the comparison detection marker.

In one or more embodiments provided by the present disclosure, the method further includes:
removing a detection marker to be processed which has an intersection over union less than the first preset threshold and is greater than or equal to a second preset threshold from the set of detection markers to be processed, wherein the second preset threshold is less than the first preset threshold.

In practical applications, there may also be some cases where the value of the intersection over union is relatively small and less than the second preset threshold, in which case, in the specific implementations provided by the present disclosure, the detection box to be processed having the intersection over union less than the second preset threshold is generally considered to belong to another target object. Therefore, in the case of processing the current detection marker, the detection box to be processed having the intersection over union less than the second preset threshold may not be considered. The second preset threshold is used to determine a preset threshold that does not belong to the same target object as the current detection marker.

In this case, there may also be some detection boxes to be processed whose intersection over union with the current detection marker is greater than or equal to the second preset threshold, but less than the first preset threshold. Such detection box to be processed cannot be determined to belong to other target objects, and also cannot be used for subsequent calculation of the target object corresponding to the current detection marker. Therefore, in the implementations provided in the present disclosure, the detection marker to be processed with an intersection over union being less than a first preset threshold and being greater than or equal to a second preset threshold can be deleted from a set of the detection markers to be processed, thereby reducing the calculation amount of subsequent calculation and improving the calculation efficiency of the target detection algorithm provided in the present disclosure.

Step B: a target detection marker corresponding to the current detection marker is determined according to the current detection marker and each comparison detection marker.

After determining the current detection marker and each of the comparison detection markers, a target detection marker corresponding to the current detection marker may be calculated from the current detection marker and each of the comparison detection markers. The current detection marker may be a reference detection marker or an initial detection marker.

Calculating the target detection marker corresponding to the current detection marker according to the current detection marker and the comparison detection marks can take the initial detection marker in the current frame for reference, and can also take the reference detection marker in the historical frame for reference, so that the final target detection can be made more accurate.

In a specific implementation provided by the present disclosure, the determining a target detection marker corresponding to the current detection marker according to the current detection marker and each aligned detection marker includes:
acquiring current detection marker pose information about the current detection marker, and acquiring comparison detection marker pose information and a comparison box weight of each comparison detection marker;
determining target detection marker pose information according to the current detection marker pose information, and the comparison detection marker pose information and the comparison box weight of each comparison detection marker; and
determining a target detection marker corresponding to the current detection marker according to the target detection marker pose information.

In an embodiment of the present disclosure, each detection marker corresponds to a set of detection marker pose information. Specifically, the detection marker pose information may include center point coordinates (x, y, z) of the detection marker, and the length, width, height, angle, etc. of the detection marker. Before the subsequent calculation, it firstly acquires pose information about the current detection marker corresponding to the current detection marker b, and at the same time acquires pose information about the comparison detection marker corresponding to each comparison detection marker bₖ.

In the target detection method provided by the present disclosure, the marker information in the reference historical frame is introduced. However, the historical frame is an already detected frame that has a certain but limited reference to the prediction of the current frame. For example, in a time series, the confidence level is higher for historical frames closer to the current frame than for historical frames farther from the current frame. Based on this, in the target detection method provided by the present disclosure, a confidence coefficient weight may be set in advance for each historical frame. When the historical frame is farther from the current frame, its confidence coefficient weight is lower. Each reference detection marker detected in the historical frame is provided with a confidence coefficient of the detection marker. The comparison box weight of each reference detection marker in the current frame may be determined according to the confidence coefficient weight of the historical frame and the detection marker confidence coefficient of the reference detection marker. Specifically, for the confidence coefficient weight corresponding to a certain reference detection marker in the i^{th} historical frame, see the following equation (6):

$$w = s \cdot {d}^{i} \qquad Equation ( 6 )$$

where, w represents a confidence coefficient weight of an i^{th} historical frame; s is a detection marker confidence coefficient of the reference detection marker; and d is a preset weight attenuation factor. For the i^{th} historical frame, its corresponding weight attenuation factor is dⁱ. By the above equation (6), it is possible to calculate a comparison box weight wₖ corresponding to the comparison detection marker k.

After the current detection marker pose information and the comparison detection marker pose information and the comparison box weight of each comparison detection marker are determined, the target detection marker pose information of the target detection marker can be calculated. See Equation (7) below for details.

$${b}_{f} = \frac{{\sum }_{k} 𝕀 ( IoU ( b , {b}_{k} ) > {h}_{high} ) {w}_{k} {b}_{k}}{{\sum }_{k} 𝕀 ( IoU ( b , {b}_{k} ) > {h}_{high} ) {w}_{k}} \qquad Equation ( 7 )$$

wherein, b_{f} represents target detection marker pose information; b represents current detection marker pose information; bₖ represents comparison detection marker pose information of a comparison detection marker k; and wₖ represents a comparison box weight of the comparison detection marker k.

In the method provided by the present disclosure, the current detection marker pose information about the current detection box and the comparison detection box marker pose information about each comparison detection box are averaged. For a reference detection marker predicted only from a historical frame, its confidence coefficient is reduced to avoid affecting the original detection effect of the current frame.

Thus, the pose information about the target detection marker corresponding to the current detection marker can be obtained.

Step C: the current detection marker and each comparison detection marker is removed from each initial detection marker and each reference detection marker, and it continues the operation of determining a current detection marker from each initial detection marker and each reference detection marker, and determines at least one comparison detection marker corresponding to the current detection marker.

After the pose information of the target detection marker is determined, it is also necessary to delete the current detection marker and each comparison detection marker configured for calculating the pose information of the target detection marker, so as to avoid these detection markers which have participated in the calculation repeatedly participate in the subsequent calculation, thereby improving the detection accuracy and calculation efficiency of the target detection method of the present disclosure.

Specifically, the removing the current detection marker and each comparison detection marker from each initial detection marker and each reference detection marker includes removing the current detection marker and each comparison detection marker from the set of detection markers to be processed.

In the above steps, each initial detection marker and each reference detection marker have been grouped into a set of detection markers to be processed. Therefore, each comparison detection marker corresponding to the current detection marker and the current detection marker can be removed directly from the set of detection markers to be processed. Thus, it is avoided to re-calculate the detection markers which have already participated in the calculation, and computational resources are saved.

After removing the current detection marker and each comparison detection marker, the next comparison detection marker corresponding to the current detection marker and the next current detection marker to be calculated will continue to be selected from the set of detection markers to be processed. For a specific selection method, reference is made to the above-mentioned relevant steps, and the description thereof will not be repeated here.

The method provided by the present disclosure repeats the above-mentioned steps until the markers in the set of detection markers to be processed are empty, i.e., until all detection boxes have been processed by weighted fusion. Heretofore, a plurality of target detection markers confirmed after a plurality of operations can be obtained. The target detection result in the current frame can then be obtained.

The present disclosure provides a target detection method that refers to a historical detection result in a historical frame during detection of an object in a current frame. By predicting the historical detection results of the historical frames, the reference detection marker of the target object in the current frame in each historical frame is predicted. Finally, a final target detection result is generated in the current frame according to the reference detection marker. The target detection method provided by the present disclosure improves the problems of false detection and missing detection caused by defects in the point cloud itself during the current target detection result, further enhancing the detection effect. At the same time, the target detection method provided by the present disclosure may not require the participation of a machine-learning neural network model, and thus may be directly fused with an existing detector, without additional model parameters, and at the same time, without incurring a higher processing delay, so that it may be applicable to more application scenarios.

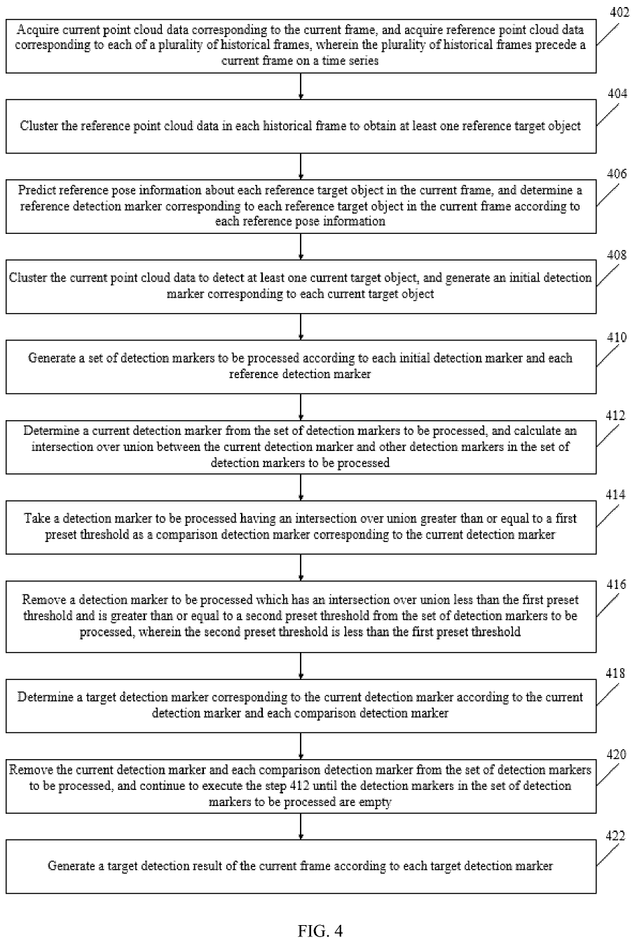

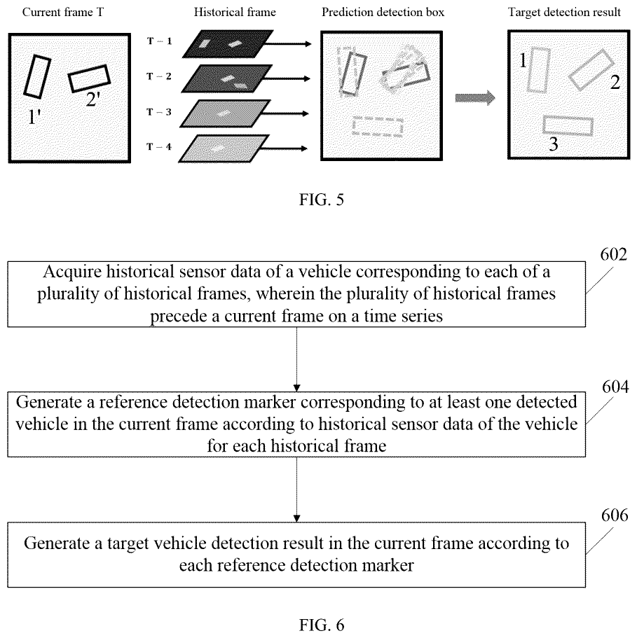

The target detection method provided in the present disclosure will be further described below with reference to FIGS. 4 and 5 as an example of its application to a roadside detection device. FIG. 4 is a process flow diagram of a target detection method applied to a roadside detection device provided by an embodiment of the present disclosure. FIG. 5 is a schematic diagram of a target detection method provided by an embodiment of the present disclosure; The target detection method specifically includes the following steps.

Step 402: current point cloud data corresponding to the current frame is acquired, and reference point cloud data corresponding to each of a plurality of historical frames is acquired, wherein the plurality of historical frames precede a current frame on a time series.

In this implementation, referring to FIG. 5, it determines a current frame T, and historical frames T−1, T−2, T−3, T−4 corresponding to the current frame.

Step 404: the reference point cloud data in each historical frame is clustered to obtain at least one reference target object.

In the present embodiment, reference point cloud data in each historical frame is clustered to obtain a corresponding reference target object in each historical frame, and reference detection boxes in each historical frame can be seen in FIG. 5.

Step 406: reference pose information about each reference target object in the current frame is predicted, and a reference detection marker corresponding to each reference target object in the current frame is determined according to each reference pose information.

In the present embodiment, the prediction detection box of each reference target object in the current frame is predicted according to the pose information of each reference target object in each historical frame, and reference can be made to the dotted line portion in the prediction detection box in FIG. 5.

Step 408: the current point cloud data is clustered to detect at least one current target object, and an initial detection marker corresponding to each current target object is generated.

In the present embodiment, after clustering the current point cloud data of the current frame T, two current target objects are detected. With reference to the current frame T in FIG. 5, an initial detection box 1′ and an initial detection box 2′ corresponding to each current target object are generated in the current frame T.

Step 410: a set of detection markers to be processed is generated according to each initial detection marker and each reference detection marker.

In this implementation, each reference detection box and the initial detection box may be used to generate a set of detection boxes to be processed for subsequent screening and calculation processing of the detection boxes.

Step 412: a current detection marker is determined from the set of detection markers to be processed, and an intersection over union between the current detection marker and other detection markers in the set of detection markers to be processed is calculated.

In this implementation, the current detection box is determined according to the detection box confidence coefficient of each detection box to be processed, and the intersection over union of the current detection box and the other detection boxes is calculated.

Step 414: a detection marker to be processed having an intersection over union greater than or equal to a first preset threshold is taken as a comparison detection marker corresponding to the current detection marker.

In this implementation, a detection box to be processed whose intersection over union is greater than a first preset threshold is taken as a comparison detection box corresponding to the current detection box.

Step 416: a detection marker to be processed which has an intersection over union less than the first preset threshold and is greater than or equal to a second preset threshold is removed from the set of detection markers to be processed, wherein the second preset threshold is less than the first preset threshold.

In this implementation, the detection boxes to be processed whose intersection over union is less than a first preset threshold and greater than or equal to a second preset threshold are deleted from the set of pending detection boxes. These deleted detection boxes to be processed do not belong to other target objects. Since it cannot be used for subsequent target detection result calculation, it needs to be eliminated.

Step 418: a target detection marker corresponding to the current detection marker is determined according to the current detection marker and each comparison detection marker.

In this implementation, the target detection marker corresponding to the current detection box can be generated by performing a weighted fusion calculation on the detection box according to the comparison between the current detection box and the current detection box.

Step 420: the current detection marker and each comparison detection marker are removed from the set of detection markers to be processed, and it continues to execute the step 412 until the detection markers in the set of detection markers to be processed are empty.

In the present embodiment, after the target detection marker corresponding to the current detection box of the current time is determined, the current detection box and the comparison detection box can be deleted from the set of detection boxes to be processed, and it can be determined whether there is a detection box in the set of detection boxes to be processed. If so, the process continues back to the step 412, and if not, the process continues to the step 422.

Step 422: a target detection result of the current frame is generated according to each target detection marker.

In this implementation, a target detection result corresponding to the current frame is generated according to each target detection marker generated in the above-mentioned step.

In this implementation, referring to FIG. 5, by performing target detection on the current frame T, a detection box 1′ and a detection box 2′ in the current frame T are obtained, and a plurality of historical frames corresponding to the current frame T are acquired simultaneously. Each historical frame includes historical frame detection data. According to the prediction of historical detection data in each historical frame, the predicted position of a certain reference target object in the historical frame in the current frame can be predicted, namely, the prediction detection box of each reference target object in the current frame can be predicted. Then, the target detection result enhanced for the current frame T, i.e., a detection box 1, detection box 2, and detection box 3, can be generated by fusing each prediction detection box and the detection box of the current frame.

With the target detection method provided by the embodiments of the present disclosure, the case of erroneous detection and missed detection due to the case of occlusion or detection error during the detection of the current frame T is avoided. For example, the detection box 3 may not be detected when only the current frame T is detected due to occlusion or the like in the current frame T. However, by predicting the historical frame, its position in the current frame T can be predicted, resulting in a better target detection result.

FIG. 6 is a flowchart of another target detection method provided by the present disclosure, which can be applied to an automatic driving scene, and specifically includes:

Step 602: vehicle historical sensor data corresponding to each of a plurality of historical frames is acquired, where the plurality of historical frames precede a current frame on a time series.

Step 604: a reference detection marker corresponding to at least one detected vehicle is generated in the current frame according to the vehicle historical sensor data of each historical frame.

Step 606: a target vehicle detection result is generated in the current frame according to each reference detection marker.

In a specific implementation provided by the present disclosure, the method further includes:
acquiring vehicle current sensor data corresponding to the current frame; and
generating at least one initial detection marker corresponding to the at least one detected vehicle in the current frame according to the vehicle current sensor data;
wherein the generating a target vehicle detection result in the current frame according to each reference detection marker includes:
generating a target vehicle detection result in the current frame according to each initial detection marker and each reference detection marker.

In a specific implementation provided by the present disclosure, the vehicle current sensor data includes current point cloud data;

the generating at least one initial detection marker corresponding to the at least one detected vehicle in the current frame according to the vehicle current sensor data includes:
clustering the current point cloud data to detect at least one currently detected vehicle; and
generating an initial detection marker corresponding to each currently detected vehicle.

In a specific implementation provided by the present disclosure, the generating an initial detection marker corresponding to each currently tested vehicle includes:
inputting a current frame including each currently detected vehicle to a vehicle detection model;
obtaining an initial detection result output by the vehicle detection model, wherein the initial detection result includes the current frame, each initial detection marker in the current frame, and initial detection marker pose information about each initial detection marker.

In a specific implementation provided by the present disclosure, the generating a target vehicle detection result in the current frame according to each initial detection marker and each reference detection marker includes:
determining a current detection marker from each initial detection marker and each reference detection marker, and determining at least one comparison detection marker corresponding to the current detection marker;
determining a target vehicle detection result corresponding to the current detection marker according to the current detection marker and each comparison detection marker;
removing the current detection marker and each comparison detection marker from each initial detection marker and each reference detection marker, and continuing the operation of determining a current detection marker from each initial detection marker and each reference detection marker, and determining at least one comparison detection marker corresponding to the current detection marker.

In a specific implementation provided by the present disclosure, the determining a current detection marker from each initial detection marker and each reference detection marker, and determining at least one comparison detection marker corresponding to the current detection marker includes:
generating a set of detection markers to be processed according to each initial detection marker and each reference detection marker;
determining a current detection marker from the set of detection markers to be processed;
calculating an intersection over union between the current detection marker and other detection markers in the set of detection markers to be processed; and
taking a detection marker to be processed having an intersection over union greater than or equal to a first preset threshold as a comparison detection marker corresponding to the current detection marker.

In a specific implementation provided by this disclosure, the method also includes:
removing a detection marker to be processed which has an intersection over union less than the first preset threshold and is greater than or equal to a second preset threshold from the set of detection markers to be processed, wherein the second preset threshold is less than the first preset threshold.

In a specific implementation provided by the present disclosure, the detection marker to be processed includes a confidence coefficient of the detection marker;
wherein the determining a current detection marker from the set of detection markers to be processed includes:
determining the current detection marker according to the confidence coefficient of the detection marker corresponding to each detection marker to be processed.

In a specific implementation provided by the present disclosure, the removing the current detection marker and each comparison detection marker from each initial detection marker and each reference detection marker includes:
removing the current detection marker and each comparison detection marker from the set of detection markers to be processed.

In a specific implementation provided by the present disclosure, the determining a target vehicle detection result corresponding to the current detection marker according to the current detection marker and each comparison detection marker includes:
acquiring current detection marker pose information about the current detection marker, and acquiring comparison detection marker pose information and a comparison box weight of each comparison detection marker;
determining target detection marker pose information according to the current detection marker pose information, and the comparison detection marker pose information and the comparison box weight of each comparison detection marker; and
determining a target vehicle detection result corresponding to the current detection marker according to the target detection marker pose information.

In a specific implementation provided by the present disclosure, the historical sensor data includes reference point cloud data;
wherein the generating a reference detection marker corresponding to at least one detected vehicle in the current frame according to historical sensor data for each historical frame includes:
for each historical frame,
clustering the reference point cloud data in the historical frame to obtain at least one reference target vehicle;
predicting reference pose information of each reference target vehicle in the current frame; and
determining a reference detection marker corresponding to each reference target vehicle in the current frame according to each reference pose information.

In a specific implementation provided by the present disclosure, the predicting reference pose information about each reference target vehicle in the current frame includes:
for each reference target vehicle,
acquiring initial reference pose information about the reference target vehicle in the historical frame; and
inputting the initial reference pose information to a motion prediction model, and obtaining reference pose information about the reference target vehicle in the current frame.

In a specific implementation provided by this disclosure, the method also includes:
determining vehicle attribute information about the reference target vehicle; and
determining a motion prediction model corresponding to the reference target vehicle according to the vehicle attribute information.

In a specific implementation provided by the present disclosure, the inputting the initial reference pose information to a motion prediction model includes:
acquiring motion parameter information about the reference target object; and
inputting the initial reference pose information and the motion parameter information into the motion prediction model.

The present disclosure provides a target detection method applied to an automatic driving scene, which refers to a historical detection result in a historical frame during detection of a vehicle in a current frame. The reference detection marker of the target vehicle in the current frame in each historical frame is predicted by predicting the history detection result of the historical frame. Finally, a final target detection result is generated in the current frame according to the reference detection marker. The target detection method provided by the present disclosure improves the problems of false detection and missing detection caused by defects in the point cloud itself during the current target detection result, further enhancing the detection effect. At the same time, the target detection method provided by the present disclosure may not require the participation of a machine-learning neural network model, and thus may be directly fused with an existing detector, without additional model parameters, and at the same time, without incurring a higher processing delay, so that it may be applicable to more application scenarios.

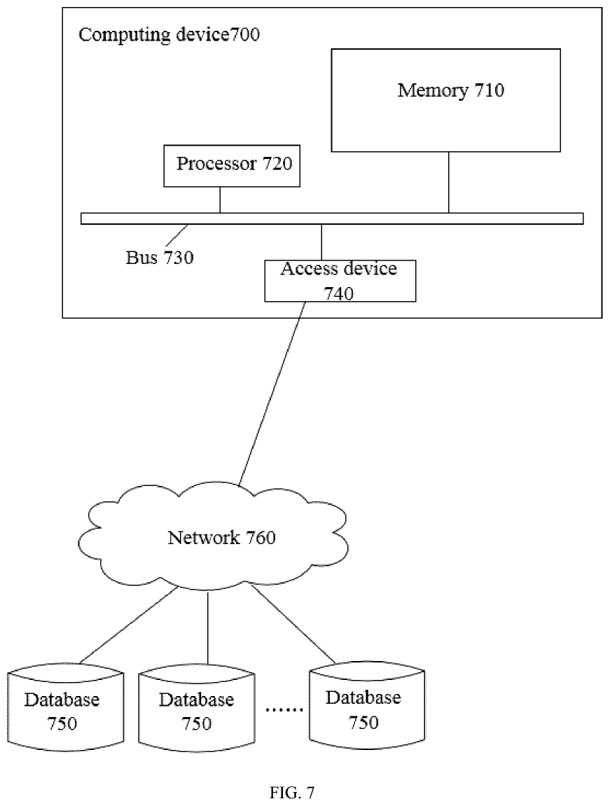

FIG. 7 shows a structural block diagram of a computing device 700 provided by an embodiment of the present disclosure. Components of the computing device 700 include, but are not limited to, a memory 710 and a processor 720. The processor 720 is coupled to the memory 710 via a bus 730. A database 750 is used to store data.

The computing device 700 also includes an access device 740 that enables the computing devices 700 to communicate via one or more networks 760. Examples of such networks include a Public Switched Telephone Network (PSTN), a Local Area Network (LAN), a Wide area network (WAN), a Personal Area Network (PAN), or a combination of communication networks such as the Internet. The access device 740 may include one or more of any type of network interface (e.g., NIC, network interface controller), wired or wireless, such as an IEEE802.11 Wireless Local Area Network (WLAN) wireless interface, a Worldwide Interoperability for Microwave Access (Wi-MAX) interface, an Ethernet interface, a Universal Serial Bus (USB) interface, a cellular network interface, a Bluetooth interface, a Near Field Communication (NFC) interface, etc.

In one embodiment of the present disclosure, the aforementioned components of computing device 700, as well as other components not shown in FIG. 7, may also be connected to each other, such as via a bus. It should be understood that the structural block diagram of the computing device shown in FIG. 7 is for exemplary purposes only and is not intended to limit the scope of the present disclosure. Other components may be added or substituted as desired by those skilled in the art.

The computing device 700 may be any type of stationary or mobile computing device, including mobile computers or mobile computing devices (e.g., tablet computers, personal digital assistants, laptop computers, notebook computers, netbooks, etc.), mobile telephones (e.g., smartphones), wearable computing devices (e.g., smart watches, smart glasses, etc.) or other types of mobile devices, or stationary computing devices such as desktop computers or Personal Computer computers (PCs). The computing device 700 may also be a mobile or stationary server.

The processor 720 implements the steps of the target detection method when executing the computer instructions.

The above is a schematic scheme of a computing device for the present embodiment. It should be noted that the technical solution of the computing device and the technical solution of the above-mentioned target detection method fall within the same concept, and reference can be made to the description of the technical solution of the above-mentioned target detection method for details of the technical solution of the computing device which are not described in detail.

An embodiment of the present disclosure also provides a vehicle including a processor that, when executing the computer instructions, implements the steps of the target detection method.

The foregoing is an exemplary aspect of a vehicle according to the present embodiment. It should be noted that the technical solution of the vehicle and the technical solution of the above-mentioned target detection method fall within the same concept, and reference can be made to the description of the technical solution of the above-mentioned target detection method for details of the technical solution of the vehicle which are not described in detail.

An embodiment of the present disclosure also provides a computer-readable storage medium that stores a computer instruction that, when executed by a processor, implements the steps of the target detection method described above.

The foregoing is an illustrative version of a computer-readable storage medium of the present embodiment. It should be noted that the technical solution of the storage medium and the technical solution of the above-mentioned target detection method fall within the same concept, and reference can be made to the description of the technical solution of the above-mentioned target detection method for details of the technical solution of the storage medium which are not described in detail.

Specific embodiments of the present disclosure are described above. Other embodiments are within the scope of the appending claims. In some cases, the acts or steps recited in the claims may be executed out of the order in the embodiments and still achieve desirable results. Additionally, the processes depicted in the figures do not necessarily require the particular order shown, or sequential order, to achieve desired results. Multi-tasking and parallel processing are also possible or may be advantageous in some implementations.

Among other things, the computer instruction includes computer program code, which may be in the form of source code, object code, executable files, or some intermediate forms. The computer-readable medium may include: any entity or device capable of carrying computer program code, recording media, a U-disk, a removable hard disk, a magnetic disk, an optical disk, a computer memory, a read-only memory (ROM), a random access memory (RAM), electrical carrier wave signals, telecommunications signals, and software distribution media. It should be noted that the contents of the computer readable media may be appropriately increased or decreased according to the requirements of the patent practice. For example, in some areas, according to the patent practice, the computer readable media does not include the electrical carrier signal and telecommunications signal.

It should be noted that each of the foregoing method embodiments, for purposes of simplicity of description, is presented as a series of combinations of acts, but those of skill in the art will know that the disclosure are not limited by the order of acts described, as some steps may occur in other orders or concurrently with other acts in accordance with the disclosure. Furthermore, those skilled in the art should also appreciate that the embodiments described in the disclosure are presently considered to be preferred, and that actions and modules involved are not necessarily for the disclosure.

In the above-mentioned embodiments, the description of each embodiment has its own emphasis, and parts of one embodiment which are not described in detail may be referred to the description of other embodiments.

The preferred embodiments of the present disclosure disclosed above are intended to be merely illustrative of the present disclosure. The optional embodiments are not intended to be exhaustive and to describe all the details, or to limit the invention to the specific implementations described. Obviously, many modifications and variations are possible in light of the present disclosure. The embodiments were chosen and described in detail in order to best explain the principles of the disclosure and its practical application to thereby enable others skilled in the art to best understand and utilize the disclosure. The present disclosure is limited only by the claims and the full scope and equivalents thereof.

What is claimed is:

1. A target detection method, comprising:
acquiring historical sensor data corresponding to a plurality of historical frames, wherein the plurality of historical frames precede a current frame;
generating at least one reference marker corresponding to at least one target object in the current frame according to the historical sensor data; and
generating a target detection result in the current frame according to the reference marker.

2. The target detection method according to claim 1, wherein the method further comprises:
acquiring current sensor data corresponding to the current frame; and
generating at least one initial marker corresponding to the at least one target object in the current frame according to the current sensor data;
wherein the generating the target detection result in the current frame according to the reference marker comprises:
generating the target detection result in the current frame according to each initial marker and each reference marker.

3. The target detection method according to claim 2, wherein the current sensor data comprises current point cloud data;
wherein the generating at least one initial marker corresponding to the at least one target object in the current frame according to the current sensor data comprises:
clustering the current point cloud data to detect at least one first target object; and
generating the initial marker corresponding to each first target object.

4. The target detection method according to claim 3, wherein the generating the initial marker corresponding to each first target object comprises:
inputting the current frame including each first target object to an object detection model; and
obtaining an initial detection result output by the object detection model, wherein the initial detection result comprises each initial marker in the current frame, and pose information of each initial marker.

5. The target detection method according to claim 2, wherein the generating the target detection result in the current frame according to each initial marker and each reference marker comprises:
determining a current marker from each initial marker and each reference marker, and determining at least one comparison marker corresponding to the current marker;
determining a target marker corresponding to the current marker according to the current marker and each comparison marker; and
removing the current marker and each comparison marker from each initial marker and each reference marker, and continuing the operation of determining the current marker from each initial marker and each reference marker, and determining at least one comparison marker corresponding to the current marker.

6. The target detection method according to claim 5, wherein the determining the current marker from each initial marker and each reference marker, and determining at least one comparison marker corresponding to the current marker comprises:
generating a set of markers to be processed according to each initial marker and each reference marker;
determining the current marker from the set of markers to be processed;
calculating an intersection over union between the current marker and other markers in the set of markers to be processed; and
taking a marker to be processed having an intersection over union greater than or equal to a first preset threshold as the comparison marker corresponding to the current marker.

7. The target detection method according to claim 6, wherein the method further comprises:
removing a marker to be processed which has an intersection over union less than the first preset threshold and is greater than or equal to a second preset threshold from the set of markers to be processed, wherein the second preset threshold is less than the first preset threshold.

8. The target detection method according to claim 6, wherein the marker to be processed has a confidence coefficient;
wherein the determining the current marker from the set of markers to be processed comprises:
determining the current marker according to the confidence coefficient of each marker to be processed.

9. The target detection method according to claim 6, wherein the removing the current marker and each comparison marker from each initial marker and each reference marker comprises:
removing the current marker and each comparison marker from the set of markers to be processed.

10. The target detection method according to claim 5, wherein the determining the target marker corresponding to the current marker according to the current marker and each comparison marker comprises:
acquiring pose information of the current marker, and acquiring pose information and a weight of each comparison marker;
determining target marker pose information according to the pose information of the current marker, and the pose information and the weight of each comparison marker; and
determining the target marker corresponding to the current marker according to the target marker pose information.

11. The target detection method according to claim 1, wherein the historical sensor data comprises historical point cloud data;
wherein the generating at least one reference marker corresponding to at least one target object in the current frame according to the historical sensor data comprises:
for each historical frame,
clustering the historical point cloud data in the historical frame to obtain at least one second target object;
predicting reference pose information of each second target object in the current frame; and
determining the reference marker corresponding to each second target object in the current frame according to each reference pose information.

12. The target detection method according to claim 11, wherein the predicting reference pose information of each second target object in the current frame comprises:
for each second target object,
acquiring initial pose information of the second target object in the historical frame; and
inputting the initial pose information to a motion prediction model, to obtain the reference pose information of the second target object in the current frame.

13. The target detection method according to claim 12, wherein the method further comprises:
determining attribute information of the second target object; and
determining a motion prediction model corresponding to the second target object according to the attribute information.

14. The target detection method according to claim 12, wherein the inputting the initial pose information to a motion prediction model comprises:
acquiring motion parameter information of the second target object; and
inputting the initial pose information and the motion parameter information into the motion prediction model.

15. A computing device comprising a memory, a processor and computer instructions stored on the memory and executable on the processor, wherein the processor, when executing the computer instructions, implements a method comprising:
acquiring historical sensor data corresponding to a plurality of historical frames, wherein the plurality of historical frames precede a current frame;
generating at least one reference detection marker corresponding to at least one target object in the current frame according to the historical sensor data; and
generating a target detection result in the current frame according to the reference detection marker.

16. The computing device according to claim 15, wherein the method further comprises:
acquiring current sensor data corresponding to the current frame; and
generating at least one initial marker corresponding to the at least one target object in the current frame according to the current sensor data;
wherein the generating the target detection result in the current frame according to each reference marker comprises:
generating the target detection result in the current frame according to each initial marker and each reference marker.

17. The computing device according to claim 16, wherein the current sensor data comprises current point cloud data;
wherein the generating at least one initial marker corresponding to the at least one target object in the current frame according to the current sensor data comprises:
clustering the current point cloud data to detect at least one first target object; and
generating the initial marker corresponding to each first target object.

18. A non-transitory computer-readable storage medium storing computer instructions, wherein the computer instructions, when executed by a processor, implement a method comprising:
acquiring historical sensor data corresponding to a plurality of historical frames, wherein the plurality of historical frames precede a current frame;
generating at least one reference detection marker corresponding to at least one target object in the current frame according to the historical sensor data; and
generating a target detection result in the current frame according to the reference detection marker.

19. The non-transitory computer-readable storage medium according to claim 18, wherein the method further comprises:
acquiring current sensor data corresponding to the current frame; and
generating at least one initial marker corresponding to the at least one target object in the current frame according to the current sensor data;
wherein the generating the target detection result in the current frame according to each reference marker comprises:
generating the target detection result in the current frame according to each initial marker and each reference marker.

20. The non-transitory computer-readable storage medium according to claim 19, wherein the current sensor data comprises current point cloud data;
wherein the generating at least one initial marker corresponding to the at least one target object in the current frame according to the current sensor data comprises:
clustering the current point cloud data to detect at least one first target object; and
generating the initial marker corresponding to each first target object.
